(19) United States
(12) Patent Application Publication
(10) Pub. No.: US 2025/0080987 A1
(43) Pub. Date: Mar. 6, 2025

(54) Randomized Timeouts for Wireless Operations

(71) Applicant: Apple Inc., CUPERTINO, CA (US)

(72) Inventors: Rohit SURESH, Fremont, CA (US); Byungkook SON, San Jose, CA (US)

(21) Appl. No.: 18/818,915

(22) Filed: Aug. 29, 2024

Related U.S. Application Data
(60) Provisional application No. 63/579,882, filed on Aug. 31, 2023.

(51) Int. Cl. H04W 12/122; H04W 4/80

(52) U.S. Cl. CPC H04W 12/122; H04W 4/80

(57) ABSTRACT

An apparatus configured to generate, for transmission to a wireless communication device via a short-range communication protocol, a request related to a short-range communication operation, select a randomized timeout period for the short-range communication operation and initiate a timer set to the randomized timeout period, wherein the wireless communication device is to respond to the request prior to expiration of the timer.

### PRIORITY/INCORPORATION BY REFERENCE

This application claims priority to U.S. Provisional Application Ser. No. 63/579,882 filed on Aug. 31, 2023 entitled “Randomized Timeouts for Wireless Operations,” the entirety of which is incorporated by reference herein.

### BACKGROUND

A first wireless communication device may be capable of establishing a short-range communication connection to a second wireless communication device, e.g., a Bluetooth connection, a Zigbee connection, a Wi-Fi Direct connection, a Thread connection, etc. When this short-range communication connection is active, there may be various operations where the first wireless communication device and second wireless communication device exchange information. These operations may have associated timeouts, e.g., a time in which one of the devices needs to respond to the other device prior to the operation being halted. These operations may also be susceptible to hackers when a hacker is aware of the time of the timeout. There is a need to prevent hackers from hacking short-range communication connections.

### SUMMARY

Some example embodiments are related to an apparatus having processing circuitry configured to generate, for transmission to a wireless communication device via a short-range communication protocol, a request related to a short-range communication operation, select a randomized timeout period for the short-range communication operation and initiate a timer set to the randomized timeout period, wherein the wireless communication device is to respond to the request prior to expiration of the timer.

Other example embodiments are related to a method including generating, for transmission to a wireless communication device via a short-range communication protocol, a request related to a short-range communication operation, selecting a randomized timeout period for the short-range communication operation and initiating a timer set to the randomized timeout period, wherein the wireless communication device is to respond to the request prior to expiration of the timer.

### BRIEF DESCRIPTION OF THE DRAWINGS

FIG. 1 shows an example arrangement according to various example embodiments.

FIG. 2 shows an example wireless communication device according to various example embodiments.

FIG. 3 shows a call flow for a successful Bluetooth Service Discovery Protocol (SDP) operation according to various example embodiments.

FIG. 4 shows a call flow for an unsuccessful Bluetooth SDP operation according to various example embodiments.

FIG. 5 shows an example method for selecting a randomized timeout for a short-range communication operation according to various example embodiments.

FIG. 6 shows a second example of wireless communication device according to various example embodiments.

### DETAILED DESCRIPTION

The example embodiments may be further understood with reference to the following description and the related appended drawings, wherein like elements are provided with the same reference numerals. The example embodiments relate to improved short-range communication connection operation behavior for wireless communication devices. Specifically, short-range communication connection operations may be implemented with randomized timeouts to, for example, prevent hackers from hijacking the short-range communication connection or injecting malicious code or data into one or more of the wireless communication devices.

The example embodiments are described with regard to wireless communication devices. As will be described in greater detail below, the wireless communication devices may include any electronic component configured with the hardware, software, and/or firmware to establish a short-range wireless connection to another wireless communication device.

The example embodiments are also described with regard to the short-range communication connection being a Bluetooth connection and the operation being a Bluetooth Service Discovery Protocol (SDP). These are only examples and the principles described herein for the example embodiments may be applied to other types of short-range communication connections (e.g., Zigbee, a Wi-Fi Direct, Thread, etc.) and other types of operations performed via the short-range communication connections, whether other Bluetooth operations (e.g., a Bluetooth disconnection supervision operation) or operations related to other types of short-range communication connections.

Furthermore, the example embodiments are described as including randomized timeouts to prevent hackers from hijacking the short-range communication connection or injecting malicious code or data into one or more of the wireless communication devices. This is only one example of an advantage of using randomized timeouts. There may be other advantages to using the randomized timeouts of the example embodiments.

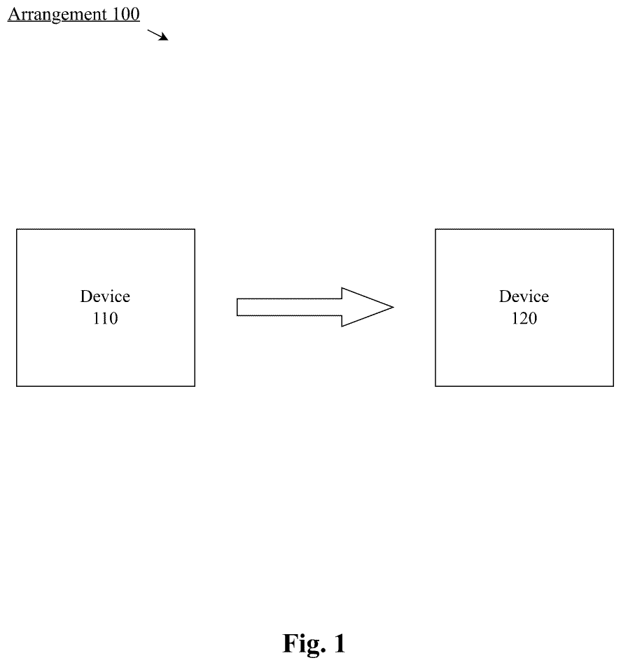

FIG. 1 shows an example arrangement 100 according to various example embodiments. The example arrangement 100 includes a first wireless communication device 110 and a second wireless communication device 120. Examples of these wireless communication devices 110 and 120 will be described in greater detail below. In the example of FIG. 1, the first wireless communication device 110 and a second wireless communication device 120 have established a short-range communication connection, e.g., a Bluetooth connection, enabling the wireless communication devices 110 and 120 to exchange information wirelessly without any intermediary devices.

The information may be exchanged using a variety of operations. In one example, the operation may include a Bluetooth Service Discovery Protocol (SDP) operation. The Bluetooth SDP allows an application executing on one of the wireless communication devices 110 and 120 to discover information about services offered by the other one of the wireless communication devices 110 and 120. For example, the wireless communication devices 110 may initiate a Bluetooth SDP operation to discover the services offered by the wireless communication devices 120.

The Bluetooth SDP operation may include a timeout, e.g., if the wireless communication device 120 does not respond within the timeout period, the wireless communication device 110 will abort or discontinue the Bluetooth SDP operation. When the Bluetooth SDP operation is ongoing and has reached the timeout period without the wireless communication device 120 responding, this provides an opportunity for a hacker to access the short-range communication connection and inject malicious information into the wireless communication device 110 by responding to the Bluetooth SDP operation right at the expiration of the timeout period. For the hacker to do this, the hacker needs to know the timeout period.

The example embodiments provide manners of preventing hackers from knowing timeout periods for operations performed over short-range communication connections. For example, the timeout periods for operations may be randomized so that hackers cannot be aware of the timeout period and access the short-range communication connection. These example embodiments will be described in greater detail below.

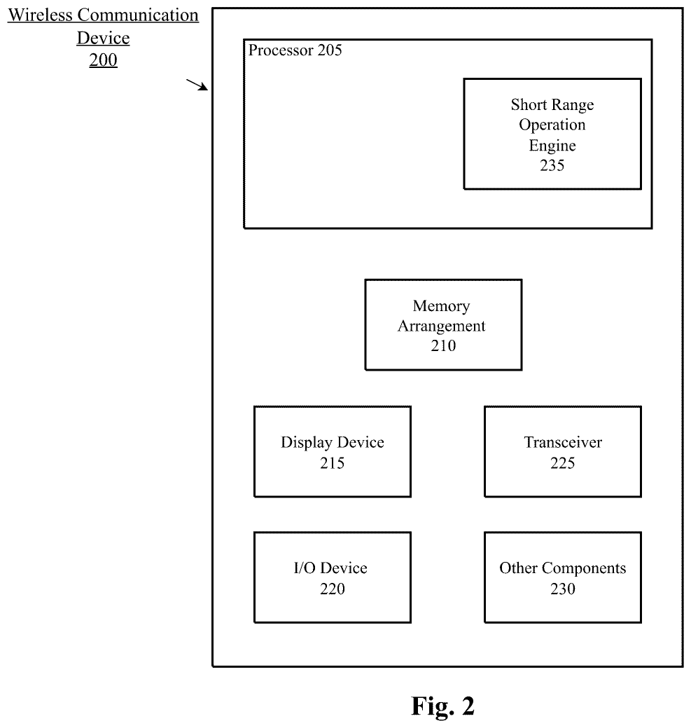

FIG. 2 shows an example wireless communication device 200 according to various example embodiments. The wireless communication device 200 of FIG. 2 may represent the wireless communication device 110 or 120 described with regard to the call forwarding arrangement 100 of FIG. 1. The wireless communication device 200 may be any type of electronic component that is configured to connect to another wireless communication device via a short-range communication connection. Non-limiting examples include mobile phones, smartphones, tablet computers, desktop computers, wearables, embedded devices, Internet of Things (IoT) devices, etc.

The wireless communication device 200 may include a processor 205, a memory arrangement 210, a display device 215, an input/output (I/O) device 220, a transceiver 225, and other components 230. The other components 230 may include, for example, an audio input device, an audio output device, a data acquisition device, ports to electrically connect to other electronic devices, sensors to detect conditions of the device, etc.

The processor 205 may be configured to execute a plurality of engines for the wireless communication device 200. For example, the engines may include a Short Range Communication Operation Engine 235 for performing operations related to the short-range communication connection, including, but not limited to, initiating a short-range communication operation and selecting a randomized timeout for the short-range communication operation. Examples of these operations will be described in greater detail below.

The above referenced engine being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some parent devices, the functionality described for the processor 205 is split among two or more processors such as a baseband processor and an applications processor. The example embodiments may be implemented in any of these or other configurations of a parent device.

The memory arrangement 210 may be a hardware component configured to store data related to operations performed by the wireless communication device 200. The display device 215 may be a hardware component configured to show data to a user, e.g., display user interfaces (UIs), text messages, etc. The I/O device 220 may be a hardware component that enables the user to enter inputs (e.g., call forwarding instructions, call forwarding acceptances/rejections, etc.). The display device 215 and the I/O device 220 may be separate components or integrated together such as a touchscreen.

The transceiver 225 may be a hardware component configured to establish a connection with one or more networks or with one or more other wireless communication devices using a short-range communication protocol, e.g., Bluetooth. Accordingly, the transceiver 225 may operate on a variety of different frequencies or channels (e.g., set of consecutive frequencies) to communicate with the networks and/or other wireless communication devices. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

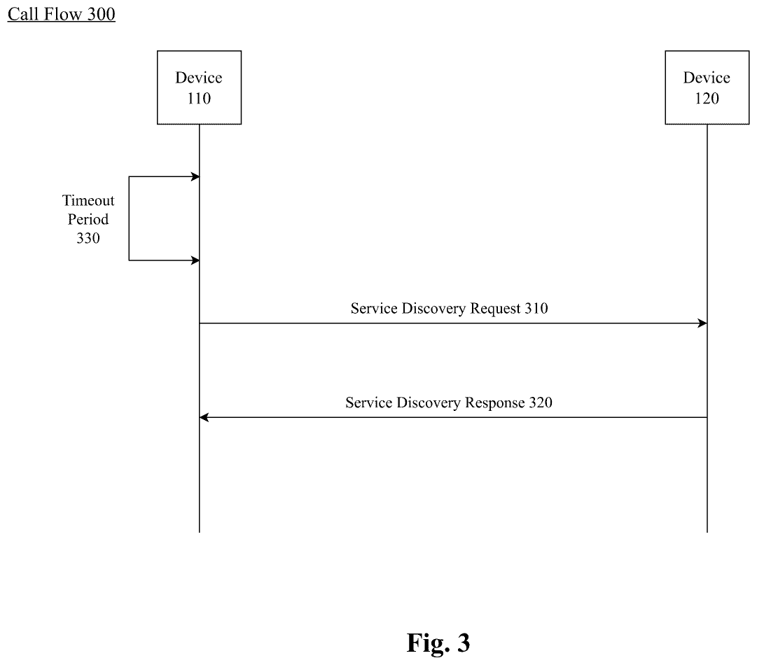

FIG. 3 shows a call flow 300 for a successful Bluetooth Service Discovery Protocol (SDP) operation according to various example embodiments. The call flow 300 is shown as occurring between the wireless communication devices 110 and 120 of FIGS. 1 and 2. In this example, the Bluetooth SDP operation is initiated by the wireless communication device 110. The Bluetooth SDP operation may be part of a larger connection process performed between the wireless communication devices 110 and 120 but for the purposes of illustration, FIG. 3 is limited to the messages exchanged during the Bluetooth SDP operation.

In 310, the wireless communication device 110 initiates the Bluetooth SDP operation by sending a service discovery request to the wireless communication device 120. The wireless communication device 110 may also initiate a timer with a timeout period 330 when the service discovery request 310 is sent. The timeout period 330 is an amount of time in which the wireless communication device 120 needs to respond to the service discovery request 310, otherwise the wireless communication device 110 will abort or discontinue the Bluetooth SDP operation. The wireless communication device 120 is not aware of the timeout period 330. However, the Bluetooth standard sets a maximum timeout period of 30 seconds.

In the example of FIG. 3, the wireless communication device 120 responds to the service discovery request 310 with a service discovery response 320 within the timeout period 330. Thus, the Bluetooth SDP operation is successful.

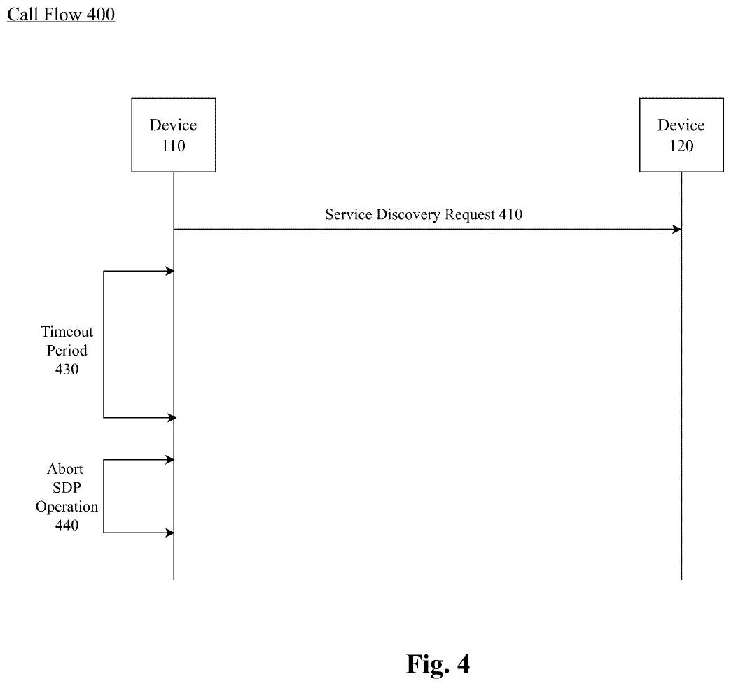

FIG. 4 shows a call flow 400 for an unsuccessful Bluetooth SDP operation according to various example embodiments. The call flow 400 is shown as occurring between the wireless communication devices 110 and 120 of FIGS. 1 and 2. In this example, the Bluetooth SDP operation is initiated by the wireless communication device 110. Again, the Bluetooth SDP operation may be part of a larger connection process performed between the wireless communication devices 110 and 120 but for the purposes of illustration, FIG. 4 is limited to the messages exchanged during the Bluetooth SDP operation.

In 410, the wireless communication device 110 initiates the Bluetooth SDP operation by sending a service discovery request to the wireless communication device 120. The wireless communication device 110 may also initiate a timer with a timeout period 430 when the service discovery request 310 is sent.

In the example of FIG. 4, the wireless communication device 120 does not respond to the service discovery request 410 within the timeout period 430. Thus, the wireless communication device 110 aborts or discontinues the Bluetooth SDP operation which results in an unsuccessful Bluetooth SDP operation.

As described above, when the Bluetooth SDP operation is ongoing and has reached the timeout period without the wireless communication device 120 responding (e.g., the end of the timeout period 430 as shown in FIG. 4), this provides an opportunity for a hacker to access the short-range communication connection and inject malicious information into the wireless communication device 110 by responding to the service discovery request 410 right at the expiration of the timeout period 430. For the hacker to do this, the hacker needs to know the timeout period 430.

In the example embodiments, the wireless communication device 110, when initiating the Bluetooth SDP operation (e.g., when sending the service discovery request 310 or 410) may generate a random timeout period (e.g., timeout period 330 or 430) in which the wireless communication device 120 needs to respond to the service discovery request. As described above, for Bluetooth SDP operations and other types of Bluetooth operations, the Bluetooth standards set a maximum time of 30 seconds for a timeout period. Thus, for the SDP operation, the wireless communication device 110 may select any timeout period up to 30 seconds. The wireless communication device 110 may have a minimum timeout period defined such that the wireless communication device 120 has enough time to receive and process the service discovery request and transmit the service discovery response within the timeout period. Thus, in this example, the timeout period for the SDP operation may be any time starting with this minimum timeout period up to the maximum timeout period of 30 seconds including fractional portions of seconds, e.g., 0.25, 0.5, etc.

Again, as stated above, the example embodiments are not limited to Bluetooth connections or Bluetooth SDP operations. Thus, other types of connections and/or operations may set different boundaries for the minimum and maximum timeout period and the wireless communication devices participating in these connections and/or operations may select a randomized value for timeout periods within these minimums and maximums.

Returning to FIG. 3, to further describe the use of the randomized timeout period of the example embodiments during a successful Bluetooth SDP operation. In 310, the wireless communication device 110 initiates the Bluetooth SDP operation by sending a service discovery request to the wireless communication device 120. The wireless communication device 110 also selects a randomized timeout period 330 and initiates a timer with this randomized timeout period 330 when the service discovery request 310 is sent. For example, the timeout period may be 7 seconds. In the example of FIG. 3, the wireless communication device 120 responds to the service discovery request 310 with a service discovery response 320 within the timeout period 330 (e.g., the 7 seconds). Thus, the Bluetooth SDP operation is successful.

Returning to FIG. 4, to further describe the use of the randomized timeout period of the example embodiments during an unsuccessful Bluetooth SDP operation. In 410, the wireless communication device 110 initiates the Bluetooth SDP operation by sending a service discovery request to the wireless communication device 120. The wireless communication device 110 also selects a randomized timeout period 430 and initiates a timer with this randomized timeout period 430 when the service discovery request 410 is sent. For example, the timeout period may be 5.5 seconds. In the example of FIG. 4, the wireless communication device 120 does not respond to the service discovery request 410 within the timeout period 430 (e.g., the 5.5 seconds). Thus, the Bluetooth SDP operation is unsuccessful.

As seen from the above examples, each individual Bluetooth SDP operation (or other operations) may have a randomized timeout period, e.g., no two Bluetooth SDP operations between the wireless communication devices 110 and 120 have the same timeout period, except for random chance of selecting a same timeout period, which is very low.

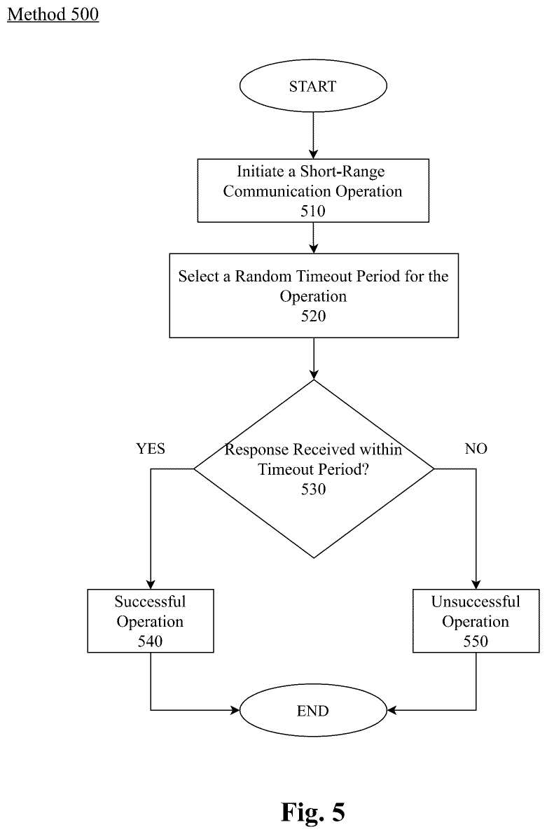

FIG. 5 shows an example method 500 for selecting a randomized timeout for a short-range communication operation according to various example embodiments. The method 500 may be performed by the wireless communication device that initiates the short-range communication operation, e.g., the wireless communication device 110.

In 510, the wireless communication device 110 initiates a short-range communication operation, e.g., the Bluetooth SDP operation. In 520, the wireless communication device 110 selects a randomized timeout period for the operation. As described above, the randomized timeout period may be selected each time a new operation is initiated. In addition, as described above, in some examples, the wireless communication device 110 may have a minimum and maximum value that may be selected for the timeout period for a particular operation. However, there is no requirement that any operation have a defined minimum and/or maximum value for the timeout period.

In 530, the wireless communication device 110 determines if the other wireless communication device, e.g., the wireless communication device 120, has responded within the randomized timeout period. If the wireless communication device 120 has responded within the randomized timeout period, the operation is successful as shown in 540. If the wireless communication device 120 has not responded within the randomized timeout period, the operation is unsuccessful as shown in 550 and the wireless communication device 110 aborts or discontinues the operation.

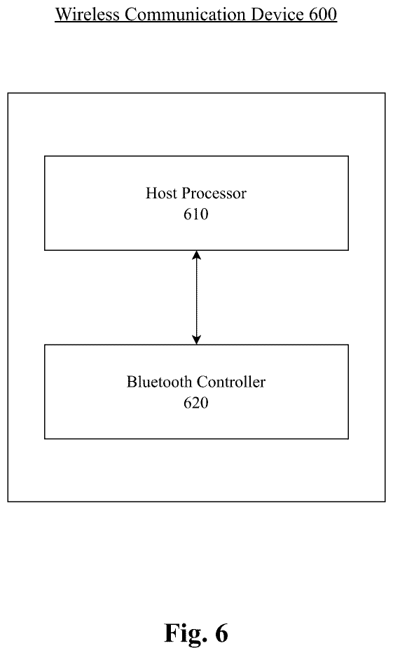

FIG. 6 shows a second example of wireless communication device 600 according to various example embodiments. The wireless communication device 600 of FIG. 6 may represent the wireless communication device 110 or 120 described with regard to the call forwarding arrangement 100 of FIG. 1.

As shown in FIG. 6, the wireless communication device 600 may implement a host processor 610 for Bluetooth operations. The host processor may be, for example, an application processor of the wireless communication device 600. The wireless communication device 600 may also implement a Bluetooth controller 620. The Bluetooth controller 620 is typically implemented in firmware of the Bluetooth radio of the wireless communication device 600 but this is not a requirement.

In some example embodiments, the randomized timeout period for the Bluetooth operation may be selected by the host processor 610. In other example embodiments, the randomized timeout period for the Bluetooth operation may be selected by the Bluetooth controller 620.

As described above, the example embodiments may prevent a hacker from accessing the short-range communication connection or the wireless communication devices using the short-range communication connection by preventing the hacker from knowing the timeout period for any particular operation.

### Examples

In a first example, a method, comprising generating, for transmission to a wireless communication device via a short-range communication protocol, a request related to a short-range communication operation, selecting a randomized timeout period for the short-range communication operation and initiating a timer set to the randomized timeout period, wherein the wireless communication device is to respond to the request prior to expiration of the timer.

In a second example, the method of the first example, further comprising processing, based on signaling received from the wireless communication device, a response to the request related to the short-range communication operation, wherein the response is received prior to expiration of the timer.

In a third example, the method of the first example, further comprising determining the timer has expired prior to receiving a response to the request related to the short-range communication operation and discontinuing the short-range communication operation.

In a fourth example, the method of the first example, wherein the short-range communication protocol comprises a Bluetooth protocol.

In a fifth example, the method of the fourth example, wherein the short-range communication operation is a Bluetooth Service Discovery Protocol (SDP) operation.

In a sixth example, the method of the fifth example, wherein the randomized timeout period has a maximum value of 30 seconds.

In a seventh example, the method of the first example, wherein the short-range communication protocol comprises a Zigbee protocol, a Wi-Fi Direct protocol, or a Thread protocol.

In an eighth example, the method of the first example, wherein the randomized timeout period is selected based on a minimum timeout period and a maximum timeout period defined for the short-range communication operation.

In a ninth example, the method of the first example, wherein the processing circuitry implements a host processor for the short-range communication protocol and the randomized timeout period is selected by the host processor.

In a tenth example, the method of the first example, wherein the processing circuitry implements a host controller for the short-range communication protocol and the randomized timeout period is selected by the host controller.

In an eleventh example, a processor configured to perform any of the methods of the first through tenth examples.

In a twelfth example, a wireless communication device configured to perform any of the methods of the first through tenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a wireless communication device via a short-range communication protocol, a request related to a short-range communication operation;
select a randomized timeout period for the short-range communication operation; and
initiate a timer set to the randomized timeout period, wherein the wireless communication device is to respond to the request prior to expiration of the timer.

2. The apparatus of claim 1, wherein the processing circuitry is further configured to:
process, based on signaling received from the wireless communication device, a response to the request related to the short-range communication operation, wherein the response is received prior to expiration of the timer.

3. The apparatus of claim 1, wherein the processing circuitry is further configured to:
determine the timer has expired prior to receiving a response to the request related to the short-range communication operation; and
discontinue the short-range communication operation.

4. The apparatus of claim 1, wherein the short-range communication protocol comprises a Bluetooth protocol.

5. The apparatus of claim 4, wherein the short-range communication operation is a Bluetooth Service Discovery Protocol (SDP) operation.

6. The apparatus of claim 5, wherein the randomized timeout period has a maximum value of 30 seconds.

7. The apparatus of claim 1, wherein the short-range communication protocol comprises a Zigbee protocol, a Wi-Fi Direct protocol, or a Thread protocol.

8. The apparatus of claim 1, wherein the randomized timeout period is selected based on a minimum timeout period and a maximum timeout period defined for the short-range communication operation.

9. The apparatus of claim 1, wherein the processing circuitry implements a host processor for the short-range communication protocol and the randomized timeout period is selected by the host processor.

10. The apparatus of claim 1, wherein the processing circuitry implements a host controller for the short-range communication protocol and the randomized timeout period is selected by the host controller.

11. A method, comprising:
generating, for transmission to a wireless communication device via a short-range communication protocol, a request related to a short-range communication operation;
selecting a randomized timeout period for the short-range communication operation; and
initiating a timer set to the randomized timeout period, wherein the wireless communication device is to respond to the request prior to expiration of the timer.

12. The method of claim 11, wherein the processing circuitry is further configured to:
processing, based on signaling received from the wireless communication device, a response to the request related to the short-range communication operation, wherein the response is received prior to expiration of the timer.

13. The method of claim 11, wherein the processing circuitry is further configured to:
determining the timer has expired prior to receiving a response to the request related to the short-range communication operation; and
discontinuing the short-range communication operation.

14. The method of claim 11, wherein the short-range communication protocol comprises a Bluetooth protocol.

15. The method of claim 14, wherein the short-range communication operation is a Bluetooth Service Discovery Protocol (SDP) operation.

16. The method of claim 15, wherein the randomized timeout period has a maximum value of 30 seconds.

17. The method of claim 11, wherein the short-range communication protocol comprises a Zigbee protocol, a Wi-Fi Direct protocol, or a Thread protocol.

18. The method of claim 11, wherein the randomized timeout period is selected based on a minimum timeout period and a maximum timeout period defined for the short-range communication operation.

19. The method of claim 11, wherein the processing circuitry implements a host processor for the short-range communication protocol and the randomized timeout period is selected by the host processor.

20. The method of claim 11, wherein the processing circuitry implements a host controller for the short-range communication protocol and the randomized timeout period is selected by the host controller.
